(19) United States
(12) Patent Application Publication
(10) Pub. No.: US 2004/0021627 A1
(43) Pub. Date: Feb. 5, 2004

(54) Drive circuit, electro-optical device and drive method thereof

(76) Inventor: Katsuhiko Maki, Chino-shi (JP)

Correspondence Address: EPSON RESEARCH AND DEVELOPMENT INC, INTELLECTUAL PROPERTY DEPT, 150 RIVER OAKS PARKWAY, SUITE 225, SAN JOSE, CA, 95134, US

(21) Appl. No.: 10/460,543

(22) Filed: Jun. 11, 2003

(30) Foreign Application Priority Data
Jun. 20, 2002 (JP) 2002-179550

(51) Int. Cl. G09G 3/36

(52) U.S. Cl. 345/89

(57) ABSTRACT

A drive circuit is provided that can drive a display panel with low power consumption, and an electro-optical device including the drive circuit and its drive method are included. The drive circuit includes voltage-setting circuits (OPA to OPC), which correspond to a plurality of data line groups SG1 to SG3 among which the data lines are divided. When the data line voltage VS varies toward one power source side, either VDDR or VSS, due to polarity change of common voltage VCOM, the voltage-setting circuits change the power source for VS to the other power source. The voltage-setting circuit changes the power source for the data line voltage VS during a period after the time when the polarity of VCOM is changed. Among the impedance conversion circuits (OPA to OPC) included in the reference voltage production circuit, the impedance conversion circuits, except for the impedance conversion circuits located at VDDR and VSS side, are employed as voltage-setting circuits.

### BACKGROUND OF THE INVENTION

1. Field of the Invention

The present invention relates to a drive circuit, an electro optical device and a drive method.

2. Description of the Related Art

Conventionally, it is well known to use a liquid crystal panel using a simple matrix system or a liquid crystal panel using an active matrix system with thin film transistors (TFT) as a liquid crystal panel used for an electronic device such as a mobile phone.

A simple matrix system has the advantage of providing a panel with lower power consumption but the disadvantage of difficulty in realizing a multicolor display and/or motion picture display. On the other hand, an active matrix system has the advantage of ease in realizing a multicolor display and/or motion picture display but the disadvantage of difficulty in providing a panel with low power consumption.

Recently, in the area of mobile type electronic equipment such as mobile phones, demand has increased for a multicolor display and/or motion picture display that provides a high quality image. Hence, a liquid crystal panel using an active matrix system has been gradually replaced with a liquid crystal panel using a simple matrix system in products for the general public.

Incidentally, in a liquid crystal panel of an active matrix system, an operational amplifier of voltage follower junction, which functions as an impedance conversion circuit, is installed in the output circuit of the data line drive circuit that drives data lines of a display panel. If such operational amplifier is installed in an output circuit, it is possible to suppress voltage drift of data line to a minimum so as to set desired gray-scale voltage of the data line in a short time.

However, when an operational amplifier is installed in an output circuit, there is a problem of increasing wastefully consumed current, namely large consumption of current. In particular, the number of the operational amplifiers is equivalent to the number of data lines. Therefore, when power consumption of each operational amplifier increases, power consumption of data line drive circuits is increased by the number of these operational amplifiers, which adds to the problem of excess power consumption.

In view of the above-mentioned technical issue, the present invention is intended to provide a drive circuit for a display panel with low power consumption, an electro-optical device including the drive circuit and a method of driving the drive circuit.

### SUMMARY OF THE INVENTION

The present invention is related to a drive circuit for driving a display panel including a plurality of pixels, a plurality of scanning lines and a plurality of data lines, the data lines being divided into a plurality of data line groups, comprising: a plurality of voltage-setting circuits each corresponding to a respective one of the plurality of data lines groups; each of the voltage-setting circuits changing a voltage source for a respective data line group to a first voltage source or a second voltage source, when the voltage of the respective data line group varies toward the other of the first voltage source or the second voltage source due to a polarity change of a voltage applied to a pixel electrode provided with each pixel in the display panel and an opposite electrode that sandwiches electro-optical material therebetween.

According to the present invention, a plurality of voltage-setting circuits is connected in a manner that, for example, a first voltage-setting circuit is connected for a first data line group, a second voltage-setting circuit is connected for a second data line group, and a third voltage-setting circuit is connected for a third data line group. And, when the data line voltage varies due to parasitic capacitance of a display panel and changing the polarity of voltage of the opposite electrode, this varied data line voltage is changed to the reversed direction by the voltage-setting circuit. Then, the first data line voltage is set to a voltage between the first and the second power sources. Hence, the data line voltage can be set to an appropriate voltage (grayscale voltage and others) thereafter so as to attain low power consumption while maintaining a better display quality.

Further, according to the present invention, each of voltage-setting circuits may change the data line's voltage source to either a first voltage source or a second voltage source during a predetermined period after the time of polarity change of the voltage of the opposite electrode.

This predetermined period is, for example, a period between the timing of changing polarity of the opposite electrode voltage and the timing of confirming or assuring writing of the data signal to a pixel electrode.

In addition, the present invention may further comprise a reference voltage production circuit that produces a plurality of reference voltages; a digital to analog conversion circuit that converts digital gray scale data to analog gray scale voltage using the plurality of reference voltages; and an output circuit that outputs analog gray scale voltage from the digital to analog conversion circuit to each data line; and wherein the plurality of the voltage-setting circuits comprise a plurality of impedance conversion circuits included in the reference voltage production circuit.

In this case, the reference voltage circuit can be used as a reference voltage circuit including a impedance conversion circuit.

Further, according to the present invention, the reference voltage circuit comprises: a first voltage division circuit that includes a ladder resistor with a plurality of resistive elements connected in series, and outputs M (M≧4) voltages to M voltage division terminals of the ladder resistor, and M impedance conversion circuits that input M voltages from the first voltage division circuit to each of a plurality of input terminals and output voltages for producing reference voltages to each of a plurality of output terminals; and the plurality of the voltage-setting circuits comprise k (2≦k≦M−2) impedance conversion circuits excluding at least the impedance conversion circuits located on the first and second power source sides among the M impedance conversion circuits.

Thus, the data line voltage can be set between the first and the second power sources.

Further, according to the present invention, the reference voltage production circuit may include a second voltage division circuit including a ladder resistor with a plurality of resistive elements connected in series, connecting M voltage division terminals of the second ladder resistor to the output terminals of M impedance conversion circuits, and outputting reference voltages to reference voltage output terminals that are N (N≧2×M) output voltage terminals of the second ladder resistor

Thus, the output impedance at N output terminals can be lowered by using impedance conversion function of M impedance conversion circuits.

Further, the present invention may further comprise a first switching element group connected between the output terminal of the digital to analog conversion circuit and the data lines, and a second switching element group connected between the output terminal of a plurality of impedance conversion circuits and the data lines, wherein; the first switching element group is turned off and the second switching element group is turned on during the period of polarity change of the opposite electrode.

Thus, the data line voltage can be set to a predetermined voltage by using the voltage-setting circuit and turning the second switching element group on. Then, the first switching element group is turned on and the second switching element group is turned off so as to set an appropriate gray scale voltage.

Further, according to the present invention, a drive circuit for driving a display panel including a plurality of pixels, a plurality of scanning lines and a plurality of data lines, comprises: a reference voltage production circuit that produces a plurality of reference voltages; a digital to analog conversion circuit that converts digital gray scale data to analog gray scale voltages using the plurality of reference voltages; and an output circuit that outputs analog gray scale voltages from the digital to analog conversion circuit to the data lines; the reference voltage production circuit comprising one or a plurality of impedance conversion circuits that changes a voltage source for the data lines to a first voltage source or a second voltage source, when the voltage of the data line voltage varies toward the other of the first voltage source or the second voltage source due to a polarity change of a voltage applied to a pixel electrode provided with the pixel in the display panel and a opposite electrode that sandwiches electro-optical material therebetween.

According to the present invention, when the data line voltage varies due to the polarity change of the opposite electrode voltage, one or a plurality of the impedance conversion circuits included in the reference voltage production circuit causes the varied data line voltage to change to the reversed direction. Then, the data line voltage is set between the first and the second power source voltages. Hence, the data line voltage can be set to an appropriate voltage (grayscale voltage and others) thereafter so as to attain low power consumption while keeping appropriate display properties.

Further, according to the present invention, the data line may be set in a high impedance state during a predetermined period including the time when the polarity of the opposite electrode voltage is changed.

Thus, electric charge flowing into the output terminal side of the drive circuit by changing polarity of the opposite electrode can be returned to a power source side so as to attain low power consumption.

In addition, the present invention relates to an electro-optical device including any of the above mentioned drive circuits and a display panel driven by the drive circuit.

Further, the present invention relates to a method for driving a display panel including a plurality of pixels, a plurality of scanning lines and a plurality of data lines, the data lines being divided into a plurality of data line groups, and a plurality of voltage-setting circuits each corresponding to a respective one of the plurality of data lines groups, comprising: changing a voltage source for a respective data line group to a first voltage source or a second voltage source, when the voltage of the respective data line group varies toward the other of the first voltage source or the second voltage source due to a polarity change of a voltage applied to a pixel electrode provided with each pixel in the display panel and an opposite electrode that sandwiches electro-optical material therebetween.

Further, the present invention relates to a method for driving a display panel including a plurality of pixels, a plurality of scanning lines and a plurality of data lines, comprising: producing a plurality of reference voltages; converting digital gray scale data to analog gray scale voltages using the plurality of reference voltages; outputting the analog gray scale voltages to the data lines; and changing a voltage source for the data lines to a first voltage source or a second voltage source, when the voltage of the data line voltage varies toward the other of the first voltage source or the second voltage source due to a polarity change of a voltage applied to a pixel electrode provided with the pixel in the display panel and a opposite electrode that sandwiches electro-optical material therebetween.

### BRIEF DESCRIPTION OF THE DRAWINGS

FIG. 1 is a block diagram of an example of an electro-optical device (a liquid crystal device).

FIG. 2 is a diagram used to describe drive with changing polarity every scanning line.

FIG. 3 is a diagram of a drive circuit including operational amplifiers.

FIGS. 4A and B show drift of data line voltage.

FIG. 5 is a diagram of a drive circuit without operational amplifiers.

FIG. 6 is a diagram showing a circuit for setting the data line to a predetermined voltage during the period after the timing period for changing polarity.

FIGS. 7A and B are examples of signal wave forms for common voltage and data line voltage.

FIG. 8 is a diagram used to describe a method for setting the data line to a predetermined voltage during the period after the time period for changing polarity.

FIG. 9 is a diagram of an example drive circuit.

FIG. 10 is a diagram used to describe a method for using operational amplifiers included in the reference voltage production circuit as the voltage-setting circuit.

FIG. 11 is a diagram showing an example of a reference voltage production circuit.

FIG. 12 is a diagram showing another example of a reference voltage production circuit.

FIG. 13 is a diagram showing a constitutional example of the first voltage division circuit.

FIG. 14 is a diagram showing an example of the first voltage division circuit.

FIG. 15 is a diagram showing an example of the second voltage division circuit.

FIG. 16 is a diagram of voltage division terminals.

FIG. 17 is a diagram showing another example of the second voltage division circuit.

FIGS. 18A and B are diagrams showing an interconnection scheme for an amorphous silicon TFT panel and a low temperature polysilicon TFT panel, respectively.

FIG. 19 is diagram used to describe a method for multiplexing and transmitting data signals for R, G, and B.

### DESCRIPTION OF THE PREFERRED EMBODIMENTS

A present embodiment is described in detail hereafter referring to drawings.

The present embodiments explained hereafter do not limit the spirit of the present invention described in the scope of the claims. In addition, all of constituents explained in the present embodiments may not be required as indispensable elements of the present invention.

1. Electro Optical Device

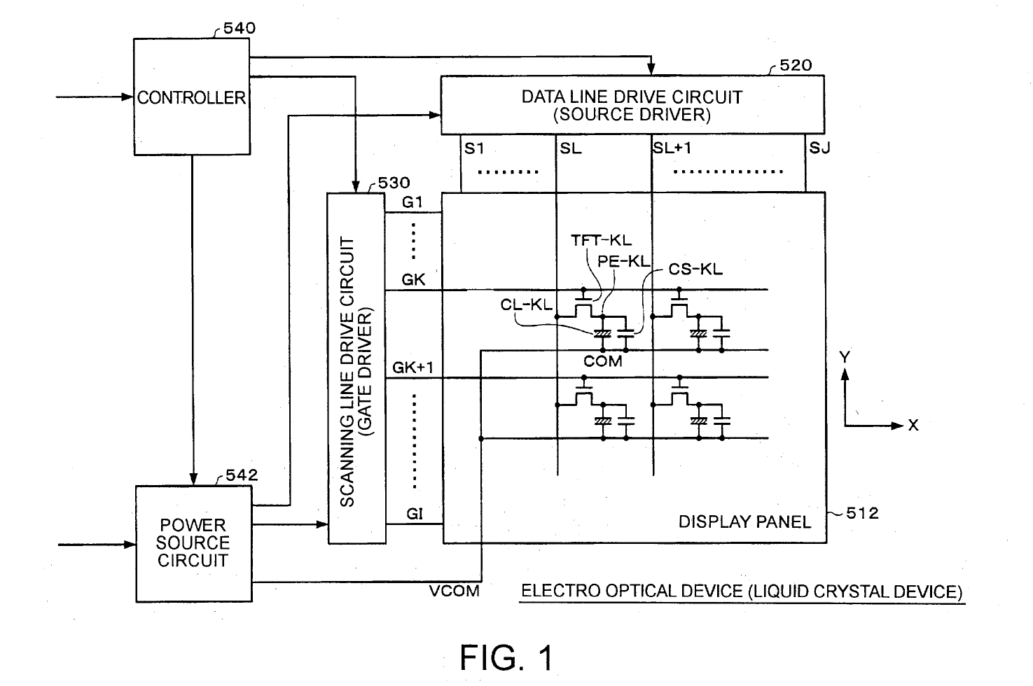

FIG. 1 shows an example of an electro-optical device of the present embodiment (e.g. a liquid crystal device). This electro-optical device can be incorporated into various types of electronic devices such as a mobile phone, a portable information appliance (such as a PDA), a digital camera, a projector, a portable audio player, a mass storage device, a video camera, personal organizer or GPS (Global Positioning System).

The electro-optical device in FIG. 1 includes a display panel 512, such as a Liquid Crystal Display (LCD) panel, a data line drive circuit 520 (e.g. a source driver), a scanning line drive circuit 530 (e.g. a gate driver), a controller 540, and a power supply circuit 542. It is not necessary to include all these circuit blocks in an electro-optical device, and some of them may be omitted in a particular device.

The display panel 512 (electro-optical panel) includes plural scanning lines (gate lines), plural data lines (source lines) and pixels specified by scanning lines and data lines. Thin film transistors TFT (more generally, switching elements for pixels) are connected to data lines and pixel electrodes so as to form an active matrix type electro-optical device.

The display panel 512 comprises an active matrix substrate (for example, a glass substrate). In this active matrix substrate, scanning lines G1 to GI (I is a natural number greater than 2) extending in the X-direction are arranged in plural rows along the Y direction, and data lines S1 to SJ (J is a natural number greater than 2) extending in the Y direction are arranged in plural columns along the X direction. A pixel is arranged at the position of the intersection of the scanning line GK (1≦K≦I, K being a natural number) with the data line SL (1≦L≦J, L being a natural number). Each pixel includes the thin film transistor TFT-KL (more generally, a switching element for a pixel), and the pixel electrode PE-KL.

A gate electrode of the TFT-KL is connected to the scanning line GK, a source electrode of the TFT-KL is connected to the data line SL and a drain electrode of the TFT-KL is connected to the pixel electrode PE-KL. A liquid crystal capacitance CL-KL (capacitance of electro-optical material) and an auxiliary capacitance CS-KL are formed between the pixel electrode PE-KL and the opposite electrode COM (common electrode), which is located oppositely to the pixel electrode PE-KL to sandwich a liquid crystal element (more generally an electro-optical material). A liquid crystal material is enclosed within the space between the active matrix substrate provided with the TFT-KL and the pixel electrode PE-KL and so on, and the opposite electrode provided with the opposite electrode COM. The transmittance ratio of the liquid crystal element is changed in response to applied voltage between the pixel electrode PE-KL and the opposite electrode COM.

A voltage VCOM applied to the opposite electrode COM (the first, and second common voltage) is produced by a power supply circuit 542. The opposite electrode COM may be arranged in stripes corresponding to each of scanning lines instead of being formed on the entire surface of the substrate.

The data line drive circuit 520 drives data lines S1 to SJ of the display panel 512 based on image data. The scanning line drive circuit 530 drives scanning lines G1 to GI of the display panel 512 with sequential scanning.

The controller 540 controls the data line drive circuit 520, the scanning line drive circuit 530 and the power supply circuit 542 in response to programmed contents in a host processor such as central processing unit (CPU) not shown in the drawing.

The controller 540 supplies the vertical synchronizing signal and the horizontal synchronizing signal, which are produced during setting of the operational mode or internally set, to the data line drive circuit 520 and the scanning line drive circuit 530. Further, the controller controls the timing of changing the polarity of the voltage VCOM applied to the opposite electrode COM for the power supply circuit 542.

The power supply circuit 542 produces various kinds of voltages, which are necessary for driving the display panel 512 and the voltage VCOM for the opposite electrode COM based on a reference voltage supplied from outside.

In FIG. 1, the electro-optical device includes the controller 540. However, the controller 540 may be physically located outside of the electro-optical device. Also, alternatively, the electro-optical device may include the host processor with the controller 540.

Further, at least one of the scanning line drive circuit 530, the controller 540, and the power supply circuit 542 may be installed within the data line drive circuit 520. In addition, a part or all of the data line drive circuit 520, the scanning line drive circuit 530, the controller 540, and the power supply circuit 542 may be installed on the display panel 512.

2. Drift of the Data Line Voltage

A liquid crystal element has a property of deterioration due to the application of a DC voltage over a long time period. Hence, a drive system that changes the polarity of voltage applied to a liquid crystal element every predetermined period is necessary. With such a drive system, the drive circuit changes polarity every frame, changes polarity every scanning line (gate line), changes polarity every data line (source line), and changes polarity every dot.

Here, a drive system that changes polarity every scanning line means that a polarity of voltage applied to a liquid crystal element is changed every scanning period (every one or plural periods). For example, a voltage of positive polarity is applied to a liquid crystal element during the K scanning interval (a period of selecting No. K scanning line), a voltage of negative polarity is applied to a liquid crystal element during the K+1 scanning interval and a voltage of positive polarity is applied to a liquid crystal element during the K+2 scanning interval. On the other hand, in the next frame, a voltage of negative polarity is applied to a liquid crystal element during the K scanning interval. A voltage of positive polarity is applied to a liquid crystal element during the K+1 scanning interval and a voltage of negative polarity is applied to a liquid crystal element during the K+2 scanning interval.

Further, in this drive system of changing polarity every scanning line, the polarity of the voltage VCOM applied to the opposite electrode COM (referred to as common voltage hereafter) is changed every scanning interval.

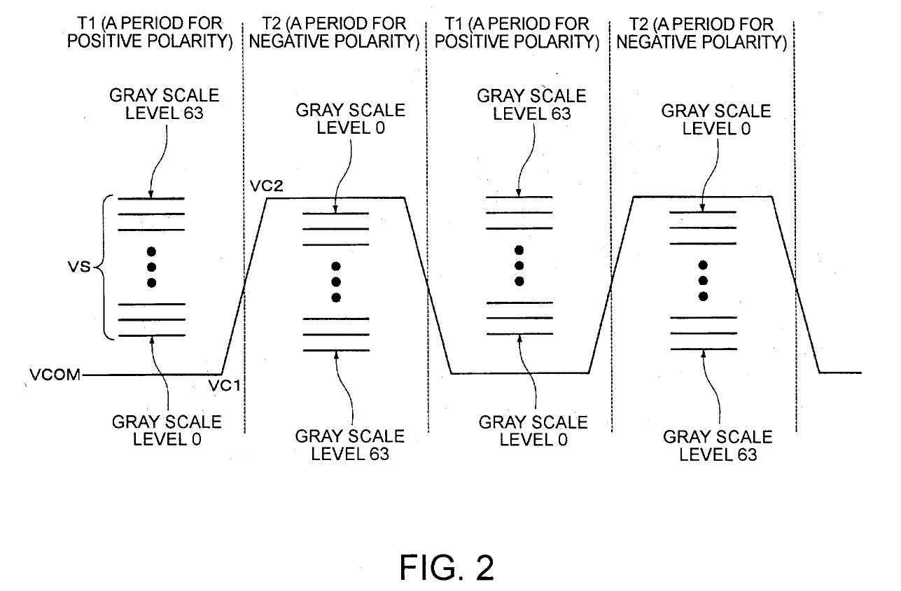

In detail, as shown in FIG. 2, the common voltage VCOM becomes VC1 (the first common voltage) during the period T1 of positive polarity (the first period) and becomes VC2 (the second common voltage) during the period T2 of negative polarity (the second period).

Here, during the period T1 of positive polarity, a voltage applied to the data line S is higher than the common voltage VCOM. A voltage of positive polarity is applied to the liquid crystal element during the period T1.

On the other hand, during the period T2 of negative polarity, a voltage applied to the data line S is lower than the common voltage VCOM. During the period T2, voltage of negative polarity is applied to the liquid crystal element. In addition, VC2 is the voltage of which the polarity is changed from that of VC1 while a predetermined voltage is defined as the reference.

Changing the polarity of the common voltage VCOM can lower the voltage that is necessary for driving a display panel. Hence, the operating voltage of a drive circuit can be lowered such that manufacturing process of the drive circuit can be simplified and its cost can be reduced.

However, there is a problem where the data line voltage (the pixel electrode voltage) drifts due to the capacitive coupling effect of the liquid crystal capacitance CL, the auxiliary capacitance CS and the parasitic capacitance in the TFT when the polarity of the common voltage VCOM is changed.

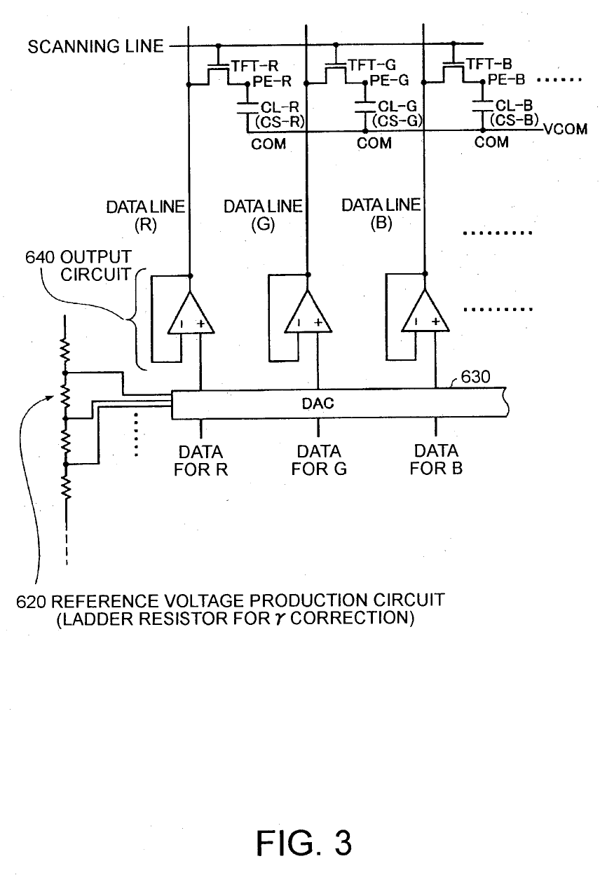

In this case, the above-mentioned problem can be overcome to some degree if a drive circuit shown in FIG. 3 is adopted.

In FIG. 3, for example, a reference voltage production circuit 620 includes a ladder resistor for gamma correction and produces a plurality of reference voltages. A digital to analog circuit (DAC) 630 converts digital gray scale data (data for R, G, B) to analog gray scale voltages by using plural reference voltages from the reference voltage production circuit 620. An output circuit 640 outputs analog gray scale voltages from the DAC 630 to the data line.

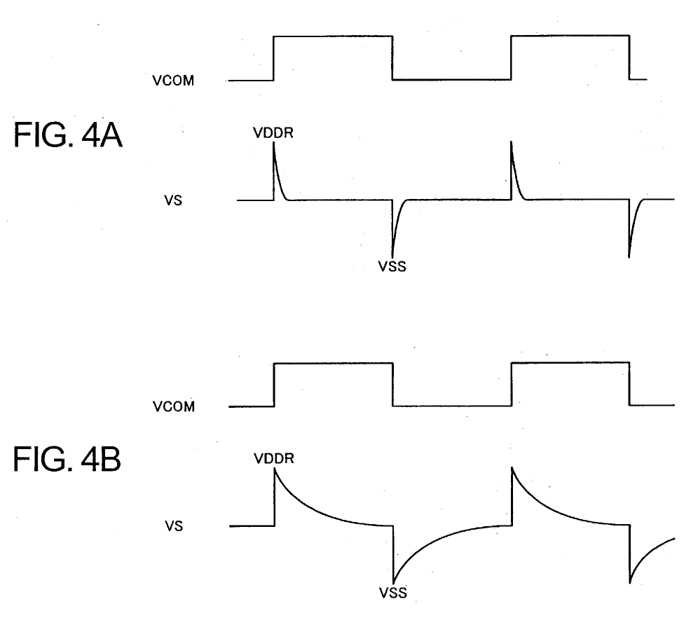

In the drive circuit shown in FIG. 3, the output circuit 640 includes an operational amplifier of voltage follower junction type (an impedance conversion circuit, generally), which drives each data line. Therefore, even if the data line voltage drifts because of changing the polarity of the common voltage, this voltage drift can be suppressed to a minimum so as to set the data line voltage (the pixel element electrode voltage) for a desired gray scale voltage shown in FIG. 4A during a short period.

However, in the drive circuit of FIG. 3, all data lines are connected to operational amplifiers having great power consumption. Hence, there is a problem where total power consumption becomes undesireably large.

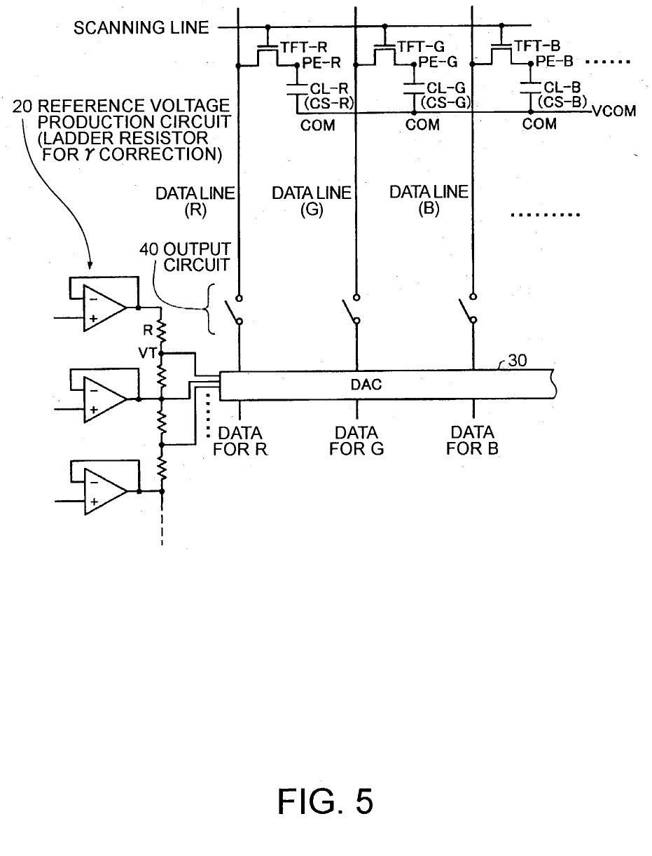

Therefore, according to the present embodiment, a drive circuit shown in FIG. 5 is adopted.

Namely, in FIG. 5, the output circuit 40 does not include operational amplifiers, but includes switching elements between the output terminal and the data line for turning on-off instead. Further, the reference voltage production circuit 20 includes operational amplifiers of voltage follower junction (impedance conversion circuits in a wide sense) instead of adopting operational amplifiers in the output circuit 40.

According to the structure in FIG. 5, the output circuit 40 does not include operational amplifiers. Therefore, in comparison with the structure in FIG. 3, the power consumption can be reduced in correspondence with the number of operational amplifiers eliminated. In particular, the effect of lowering power consumption is great when there are a large number of data lines.

However, in the structure of FIG. 5, there is a problem in that it is difficult to set the data line voltage for a desired gray scale voltage during a short time due to the removal of the operational amplifiers in the output circuit 40, when the data line voltage (the pixel electrode voltage) drifts by changing the polarity of common voltage VCOM. Namely, as shown in FIG. 4B, there is a problem in that it takes too much time to return the data line voltage to appropriate voltage such that the data line voltage cannot be set to a desired voltage within the time required to assure a proper voltage of the pixel electrode PE.

In this case, such problem can be overcome to some degree by including operational amplifiers (impedance conversion circuits) in the reference voltage production circuit 20 as shown in FIG. 5.

However, even if operational amplifiers are included in the reference voltage production circuit 20 as shown in FIG. 5, it takes considerable time for the data line to reach a desired voltage when the polarity of the common voltage VCOM is changed when writing the reference voltage from the voltage division terminal VT as a gray scale voltage to all pixels. Namely, the time of reaching a desired voltage is delayed by the time constant determined with the resistance value of the ladder resistor (R) and the parasitic capacitance (CL, CS, data line capacitance and others). Further, if the resistance value of the ladder resistor is decreased in order to avoid such situation, there is a problem in which current constantly flowing in the ladder resistor is increased so as to increase the power consumption of the reference voltage production circuit 20.

Hence, according to the structure of FIG. 5, there is an advantage of reducing the power consumption of the output circuit 40, while there is a problem in that it becomes difficult to control the drift of the data line voltage (the pixel electrode voltage) and the power consumption of the reference voltage production circuit 20 is increased.

3. Setting Data Line Voltage in Changing Polarity

In order to overcome the above-mentioned problem, the following drive technique is adopted in the present embodiment.

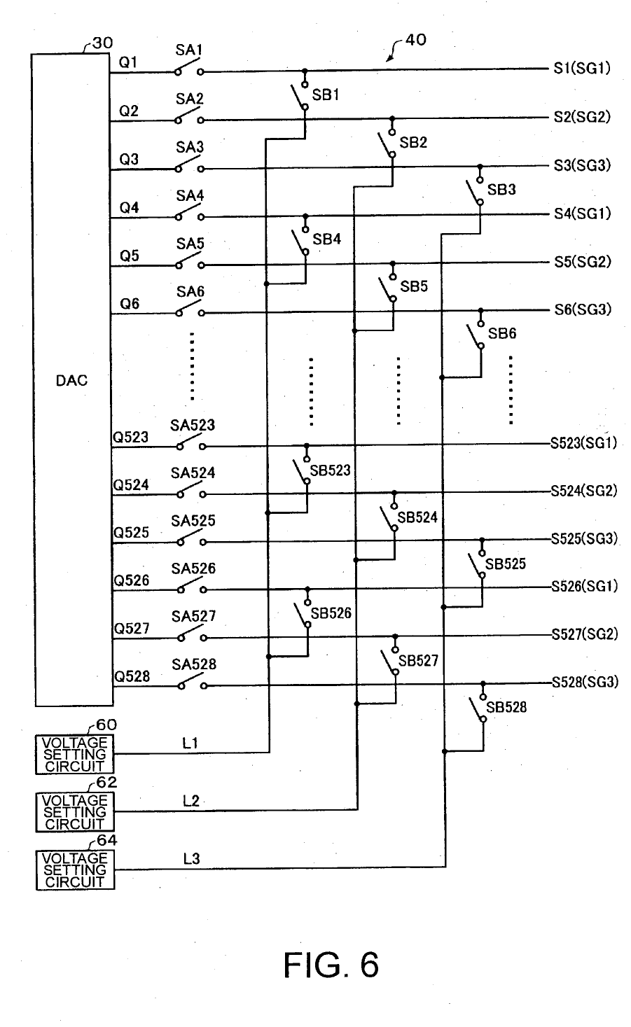

Namely, in the present embodiment, as shown in FIG. 6, voltage-setting circuits 60, 62, 64 (for example, impedance conversion circuits) correspond to each data line group SG1, SG2 and SG3, respectively, with the data lines being divided among these three groups. Further, there may be a structure with just a single voltage-setting circuit instead of a plurality of them.

Here, the data line group SG1 includes the group of data lines S1, S4, S7 . . . S523, S526 and the data line group SG 2 includes the group of data lines S2, S5, S8 . . . S524, S527. In addition, the data line group SG 3 includes the group of data lines S3, S6, S9 . . . S525, S528. Further, the voltage-setting circuit 60 sets voltages of the data line group SG1 (S1, S4 . . . S526); the voltage-setting circuit 62 sets voltages of the data line group SG (S2, S5 . . . S527); and the voltage-setting circuit 64 sets voltages of the data line group SG3 (S3, S6 . . . S528).

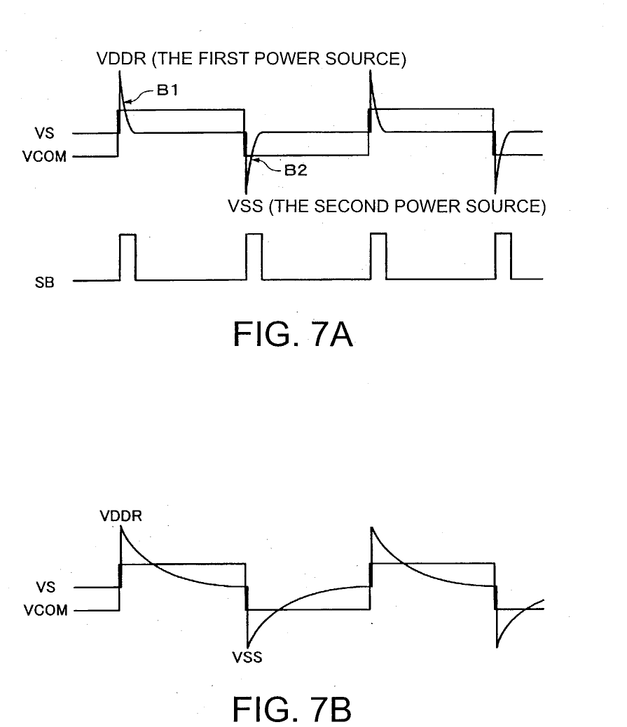

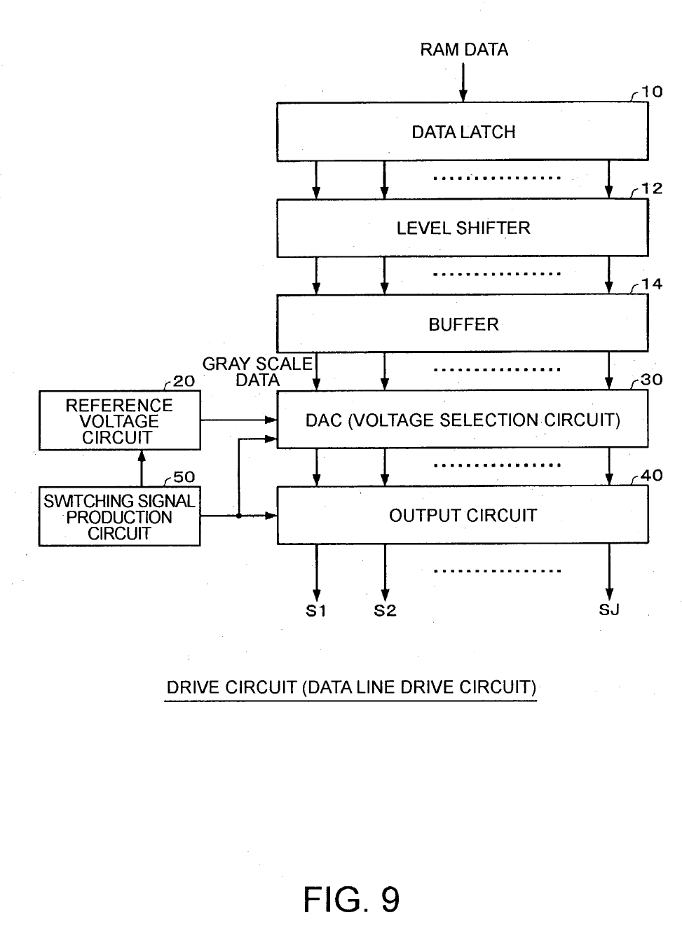

Further, according to the present invention, as shown in an example of a signal wave form in FIG. 7A, when the data line voltage VS varies toward one voltage side, either toward the VDDR (the first power source) side or toward the VSS (the second power source) side due to a polarity change of voltage VCOM applied to the opposite electrodes, the voltage-setting circuits 60, 62 and 64 change the data line voltage VS to the other power source side. The VDDR (first) and VSS (second) power sources are used to produce the reference voltages in the production of the digital gray scale data as described later with reference to FIG. 9.

Namely, the data line voltage VS is changed to a voltage (an intermediate voltage between VDDR and VSS) at another electrode side during a predetermined period after timing of changing polarity of VCOM (a predetermined period between the timing of polarity change and the timing of confirming writing of data signal into a pixel electrode).

For example, when the data line voltage VS varies toward the VDDR side (one side) due to the polarity change of the common voltage VCOM, the voltage-setting circuits 60, 62, 64 change the reference source voltage (i.e. the voltage used to make voltage VS) to VSS (another side) as shown in B1 of FIG. 7A. Alternately, when VS varies toward the VSS side (one side) due to polarity change of VC OM, the reference source voltage for VS is changed to the VDDR side (another side) as shown in B2.

Hence, even if the data line voltage VS (pixel electrode voltage) varies due to polarity change of common voltage VCOM, VS can be set to desired gray scale voltage within a short time.

For example, an example of a signal waveform in a case of not using the method of the present embodiment is shown in FIG. 7B. There is no setting of the data line voltage VS by the voltage-setting circuit during a period of polarity change of VCOM in FIG. 7B. Therefore, it takes a long time to return the data line voltage VS to an appropriate voltage such that there is a problem in that it is not returned to the appropriate voltage within the time period for confirming pixel electrode voltage to set the data line voltage VS to desired gray scale voltage.

On the other hand, according to the present embodiment, such problem can be overcome as shown in FIG. 7A. Further, even when the circuit structure shown in FIG. 5, is adopted, the data line voltage VS can be set to an appropriate voltage during a short time.

In addition, in the present embodiment, the data lines S1 to S528 are divided into groups SG1, SG2 and SG3, corresponding to the a plurality of the voltage-setting circuits 60, 62, and 64. Therefore, even when a large electric current flows between the display panel and the voltage-setting circuits, at the time of setting the data line voltage, it is possible to disperse this large current through a plurality of lines L1, L2, and L3. Therefore, disconnection of the lines L1, L2 and L3 from voltage-setting circuits 60, 62 and 64 due to over-current can be prevented.

Further, data lines are divided into three groups SG1, SG2, and SG3, in FIG. 6. However, they may be divided into two groups, or four groups or more. In addition, the grouping is arbitrary and, for example, SG1 may include S1 to S176, SG2 may include S177 to S352 and SG3 may include S353 to S528.

In addition, in FIG. 6, three voltage-setting circuits 60, 62, and 64 are included. However, two voltage-setting circuits may be included instead or four or more voltage-setting circuits may be included.

In FIG. 6, switching elements SA1 to SA 528 (the first switching element group) are arranged between data lines S1 to S528 and the output terminals Q1 to Q528 of the DAC 30 (the digital to analog circuit).

In addition, switching elements SB1 to SB528 (the second switching element group) are arranged between the output terminals of the voltage-setting circuits 60, 62, and 64 (impedance conversion circuits) and the data lines S1 to S528.

In detail, the switching elements SB1, SB4 . . . SB523, SB526 are connected between the output terminal (L1) of the voltage-setting circuit 60 and the data lines S1, S4 . . . S523, S526 (the data line group SG1). The switching elements SB2, SB5 . . . SB524, SB527 are connected between the output terminal (L2) of the voltage-setting circuit 62 and the data lines S2, S5 . . . S524, S527 (the data line group SG 2). Switching elements SB3, SB6 . . . SB525, SB528 are connected between the output terminal (L3) of the voltage-setting circuit 64 and the data lines S3, S6 . . . S525, S528 (the data line group SG3).

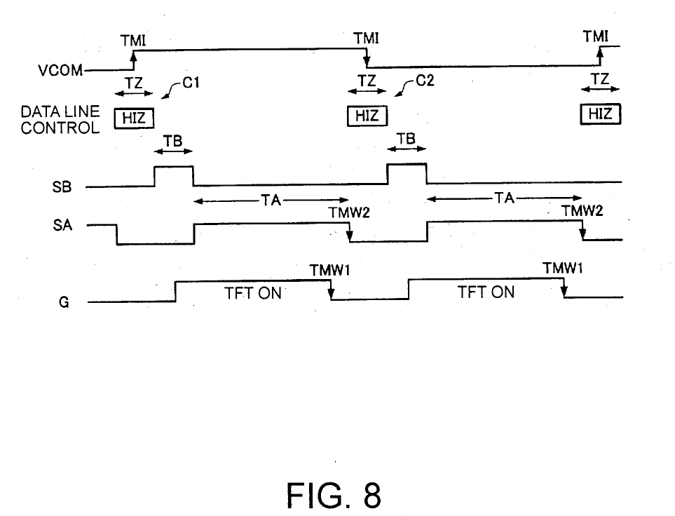

Further, according to the embodiment, as shown in FIG. 8, the switching elements SA1 to SA528 (the first switching element group) are turned off during the period TB after the timing TMI of polarity change of VCOM (the period between the timing TMI of polarity change and the timing of confirming or assuring writing data signal TMW1 or TMW2). In addition, the switching elements SB1 to SB528 (the second switching element group) are turned on.

Namely, during the period TB, the switching signal SA, which controls turning switching elements SA1 to SA528 on or off becomes deactivated (the level for turning a switching element off). In addition, the switching signal SB, which controls turning switching elements SB1 to SB528 on or off becomes activated (the level for turning a switching element on).

Then, during the period TA following TB, the switching signal SA is activated, switching elements SA1 to SA528 are turned on. In addition, the switching signal SB is deactivated, the switching elements SB1 to SB528 are turned off.

Hence, as shown in B1 and B2 of FIG. 7A, during the period when the switching signal SB is activated, the voltage-setting circuits 60, 62 and 64 set the source voltage so as to change the voltages of data lines S1 to S528 to the VSS side or VDDR side. Then, during the period TA following the period TB, voltage of the data lines S1 to S528 can be set to appropriate voltage (to represent the digital gray scale value) from the DAC30.

In addition, according to the present embodiment, shown as C1 and C2 of FIG. 8, the data line is set in the high impedance state during the period TZ including the timing TMI of polarity change for the common voltage VCOM. This can be realized by turning off the switching elements SA1 to SA 528, and SB1 to SB528 together.

Hence, if the data line is set in the high impedance state, it is possible to return charge, which flows into the output terminal side of the drive circuit, to the power source side so as to realize low power consumption.

Further, switching elements explained in the present embodiment (SA1 to SA 528, SB1 to SB528 and switching elements described below) may be realized with a N type transistor and a P type transistor, or may be realized with a transfer gate type (a gate formed by connecting a drain region of a P type transistor and a source region to a N type transistor mutually).

4. Structure of a Drive Circuit

FIG. 9 shows an example of a drive circuit (a data line drive circuit) of the present embodiment.

This drive circuit includes a data latch 10, a level shifter 12, and a buffer 14. In addition, it further includes the reference voltage production circuit 20, the DAC 30 (a digital to analog conversion circuit, a voltage selection circuit, and a voltage generation circuit), an output circuit 40, and a switching signal production circuit 50. All these circuits may not be necessary and a part of the circuit blocks shown may be omitted in a particular structure.

In FIG. 9, the data-latch 10 latches data from RAM that is a display memory. The level shifter 12 shifts the level of voltage outputted from the data latch 10. The buffer 14 buffers data from level shifter 12, and outputs it to the DAC 30 as digital gray scale data.

The reference voltage production circuit 20 produces plural reference voltages to form a gray scale voltage. In detail, the reference voltage production circuit 20 includes a ladder resistor where plural resistance elements are connected in series. Then, the reference voltages are produced at the voltage division terminals (reference voltage production terminals) of the ladder resistor.

In this case, it is desirable to include an impedance conversion circuit as shown in FIG. 5 (e.g. an operational amplifier of voltage follower junction type) in the reference voltage production circuit 20. In detail, the reference voltage production circuit 20 includes the first and second voltage division circuits and inputs M (for example, 7) voltages from M voltage division terminals of the ladder resistor, included in the first voltage division circuit, into M input terminals of the impedance conversion circuit. In addition, M voltage division terminals of the ladder resistor, included in the second voltage division circuit, are connected to M output terminals of the impedance conversion circuits, while N (for example, 64) reference voltages are outputted to the output terminals for reference -voltages, which are N(N≧2×M) voltage division terminals of the ladder resistor.

The DAC 30 converts digital gray scale data from the buffer 14 to the analog gray scale voltage by using plural reference voltages from the reference voltage production circuit 20. Digital gray scale data is decoded and any one of a plurality of reference voltages is selected based on the decoded results and the selected reference voltages are output to the output circuit 40. The decoder included in this DAC 30 can be realized by using a ROM, for example.

The output circuit 40 is a circuit for transmitting an analog gray scale voltage from the DAC 30 to the data lines. This output circuit 40 can include switching elements for controlling turning the connection between the output terminals of the DAC 30 and the data lines on or off (switching elements for setting data lines in a high impedance state at the time of polarity change of common voltage). Further, in detail, this output circuit 40 can include switching elements SA1 to SA528 and SB1 to SB528 as shown in FIG. 6.

The switching signal production circuit 50 produces switching signals for controlling turning the various kinds of switching elements on or off, which are included in the reference voltage production circuit 20, the DAC 30, and the output circuit 40. In detail, the switching signal production circuit 50 produces switching signals SA, SB and others for controlling turning switching elements SA1 to SA528, and SB1 to SB528, described in FIG. 6, on or off.

5. Reference Voltage Production Circuit

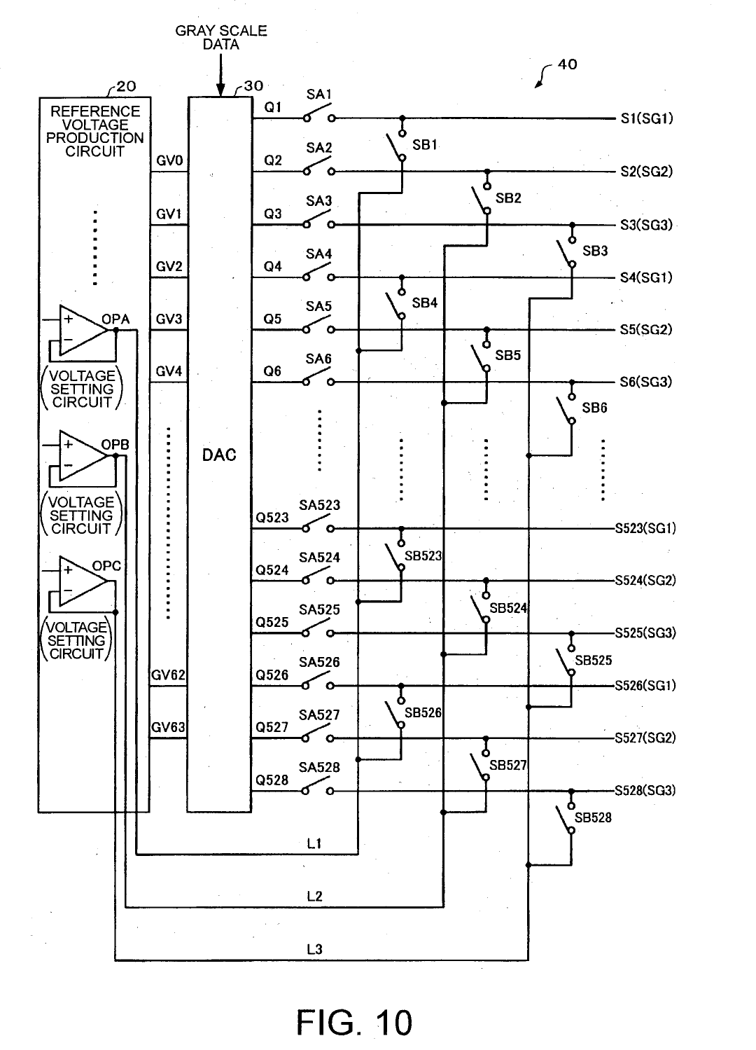

Preferably, as voltage-setting circuits 60, 62 and 64 shown in FIG. 6, it is desirable to use operational amplifiers of the voltage follower junction type, OPA, OPB and OPC (generally, impedance conversion circuits) included in the reference voltage production circuit 20 as shown in FIG. 10. In detail, a line L1 connected to switching elements SB1, SB4 to SB526 (the switching element group SG1) is connected to the operational amplifier OPA of the reference voltage production circuit 20; a line L2 connected to switching elements SB2, SB5 to SB527 (the switching element group SG2) is connected to the operational amplifier OPB; and, a line L3 connected to switching elements SB3, SB6 to SB528 (the switching element group SG3) is connected to the operational amplifier OPC.

Hence, there is no requirement of installing a new, separate voltage-setting circuit for pulling data line current (electric charge) so that a small circuit (fewer elements) can be realized.

Namely, according to the present embodiment, as described in FIG. 5, the reference voltage production circuit 20 includes operational amplifiers instead of installing operational amplifiers between the DAC 30 and the data line. Hence, the smaller sized (fewer elements) circuit and low power consumption can be attained by forming a structure as in FIG. 5 as compared with the structure in FIG. 3, in which all data lines are connected to operational amplifiers.

Further, according to the present embodiment, in order to utilize the operational amplifiers OPA, OPB, and OPC included in this reference voltage production circuit 20 more effectively, these OPA, OPB and OPC are also used as the voltage-setting circuits 60, 62, and 64 in FIG. 6.

Hence, by-pass connection (direct connection) can be attained between switching elements SB1 to SB528 and operational amplifiers OPA, OPB and OPC (voltage-setting circuits) by using the line L1 to L3. Namely, the outputs of the operational amplifiers OPA, OPB, and OPC are connected to the switching elements SB1 to SB528 without interposing the resistive elements included in the reference voltage production circuit 20. Hence, the output impedance of the drive circuit, viewed from data lines S1 to S528 can be lowered. As a result, as shown in B1 and B2 of FIG. 7(A), the data line voltage VS can be set to a desired voltage in a short time so as to improve display quality.

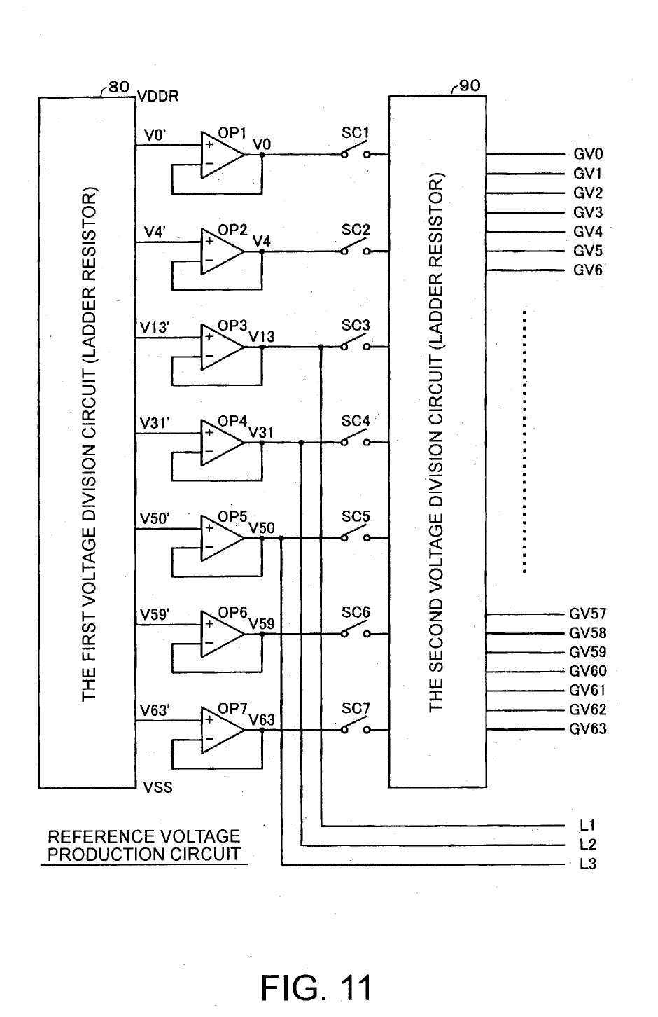

FIG. 11 is an example of the reference voltage production circuit 20.

This reference voltage production circuit 20 includes a first voltage division circuit 80 which outputs voltages V0′, V4′, V13′, V31′, V50′, V59′, V63′ (M voltages) to the seven voltage division terminals (M voltage division terminals).

In addition, the reference voltage production circuit 20 includes operational amplifiers of the voltage follower junction type OP1, OP2, OP3, OP4, OP5, OP6, and OP7 (M impedance conversion circuits) that receive on their input terminals input voltage V0′, V4′, V13′, V31′, V50′, V59′ and V63′ respectively from the first voltage division circuit. These operational amplifiers OP1 to OP7 output voltages V0, V4, V13, V31, V50, V59, and V63 to the output terminals to produce reference voltages GV0 to GV63.

In addition, the reference voltage production circuit 20 includes switching elements SC1 to SC7 (the third switching element group), which are installed between operational amplifiers OP1, OP2, OP3, OP4, OP5, OP6, and OP7 and the second voltage division circuit 90.

In addition, the reference voltage production circuit 20 includes a second voltage division circuit 90 with seven voltage division terminals (generally, M voltage division terminals) connected to the output terminals of operational amplifiers OP1 to OP 7 via the switching elements SC1 to SC 7. Reference voltages are output to its reference voltage output terminals, which are sixty four (64) voltage division terminals (generally, N voltage division terminals).

According to the present embodiment, operational amplifiers OP3, OP4, and OP5 included in the reference voltage production circuit 20 of FIG. 11 are used as the voltage-setting circuits 60, 62 and 64 in FIG. 6 (OPA, OPB, and OPC in FIG. 10). Namely, among seven (M) operational amplifiers OP1 to OP7 (impedance conversion circuits), three (generally, k) operational amplifiers OP3, OP4, OP5, in the middle of operational amplifiers OP1, OP2 on the VDDR (the first power source) side and OP6 and OP7 on the VSS (the second power source) side, are used as voltage-setting circuits 60, 62 and 64 in FIG. 6. Generally, the voltage-setting circuits comprise k impedance conversion circuits (2≧k≦M−2) excluding at least the impedance conversion circuits that are located on the first and second power source sides.

In this case, the output voltages V13, V31, and V50 of operational amplifiers OP3, OP4 and OP5 (the input voltages V13′, V31′, and V50′), become intermediate voltages between VDDR (the first power source) and VSS (the second power source). Therefore, if the data line voltage VS is set by using these output voltages V13, V31 and V50 of the operational amplifiers OP 3, OP 4, and OP 5, VS can be set to intermediate voltage between VDDR and VSS. Therefore, as shown in B1 and B2 of FIG. 7A, the data line voltage VS can be set to a gray scale voltage after setting VS as intermediate voltage between VDDR and VSS.

Namely, if the data line voltage VS is set to a voltage, which is close or equal to VDDR and VSS, there is a problem in that it takes too much time to set VS to the desired gray scale voltage thereafter. However, according to the present embodiment, operational amplifiers OP3, OP4, and OP5, located in intermediate portion between VDDR and VSS, are used as the voltage-setting circuits 60, 62 and 64 instead of the operational amplifiers OP1, OP2, OP6, or OP7 located on the VSS side and the VDDR side, so as to eliminate the above problem.

In addition, according to the present embodiment, voltage setting is implemented for every data line group by using a plurality of operational amplifiers OP3, OP4, and OP5 so as to decrease the amount of current flowing into the lines L1, L2 and L3 and prevent their disconnection due to electro-migration or overcurrent.

In addition, in FIG. 11, operational amplifiers OP2, OP3, OP4, OP5, and OP6 may be used as voltage-setting circuits, or only OP3 and OP4 may be used as voltage-setting circuits, or only OP4 and OP5 may be used as voltage-setting circuits. Namely, according to the present embodiment, optionally chosen operational amplifiers, except the operational amplifiers OP1 and OP7, can be employed as voltage-setting circuits.

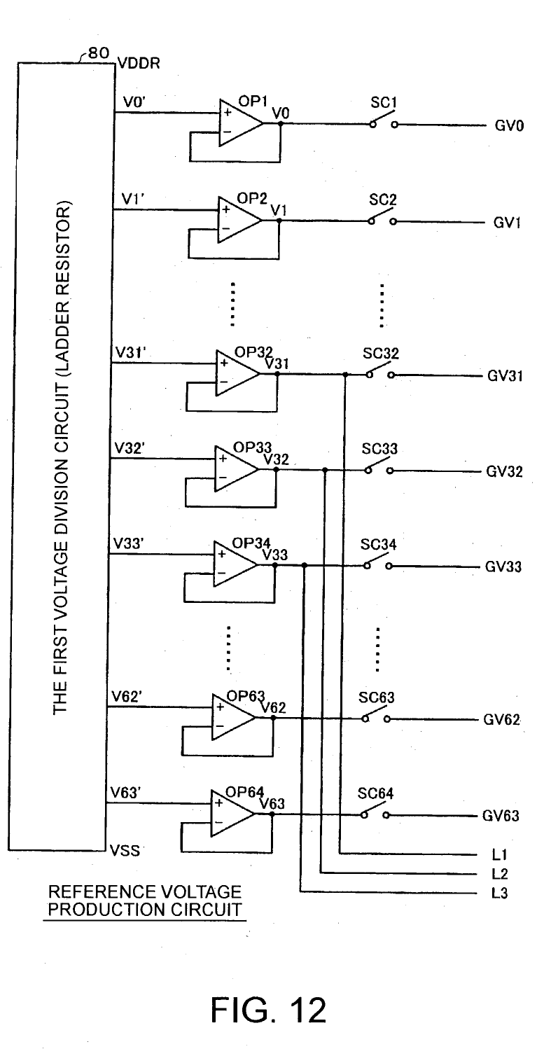

In addition, as shown in FIG. 12, in the reference voltage production circuit 20, only the first voltage division circuit 80 may be installed without installation of the second voltage division circuit 90.

Namely, in FIG. 12, the first voltage division circuit 80 outputs voltage V0′ to V63′ to the voltage division terminals. Then, these voltages V0′ to V63′ are input into the input terminals of the operational amplifiers OP1 to OP64 (impedance conversion circuits). Then, operational amplifiers OP1 to OP64 output reference voltages GV0 to GV63 to reference voltage output terminals via switching elements SC1 to SC64.

In this case, optionally chosen operational amplifiers except OP1 and OP64 at the VDDR and VSS sides (such as operational amplifiers OP32, OP33 and OP34 and others located in between VDD and VSS) can also be used as voltage-setting circuits.

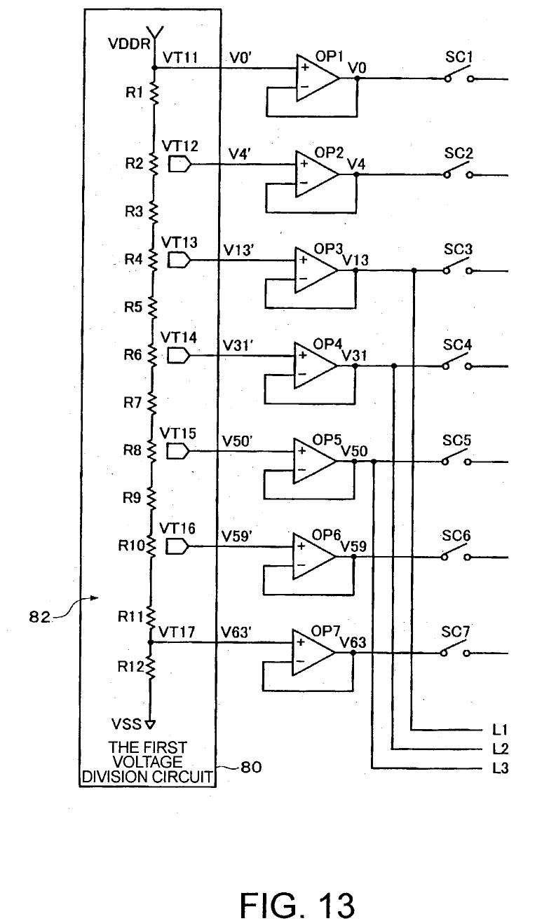

FIG. 13 shows an example of the first voltage division circuit 80.

This first voltage division circuit 80 includes a ladder resistor 82 with a plurality of resistor elements R1 to R12 connected in series between the power sources VDDR and VSS. Voltages V0′, V4′, V13′, V31′, V50′, V59′ and V63′ are output from voltage division terminals VT11 to VT17 of the ladder resistor 82.

In FIG. 13, voltage division terminals VT12 to VT16 are voltage division terminals, which can select any taps from 8 taps of resistors R2 to R10. Any tap can be selected by setting a resistor value in a register (4 bits), for example. Hence, various kinds of gamma correction characteristics can be obtained depending on which taps are selected.

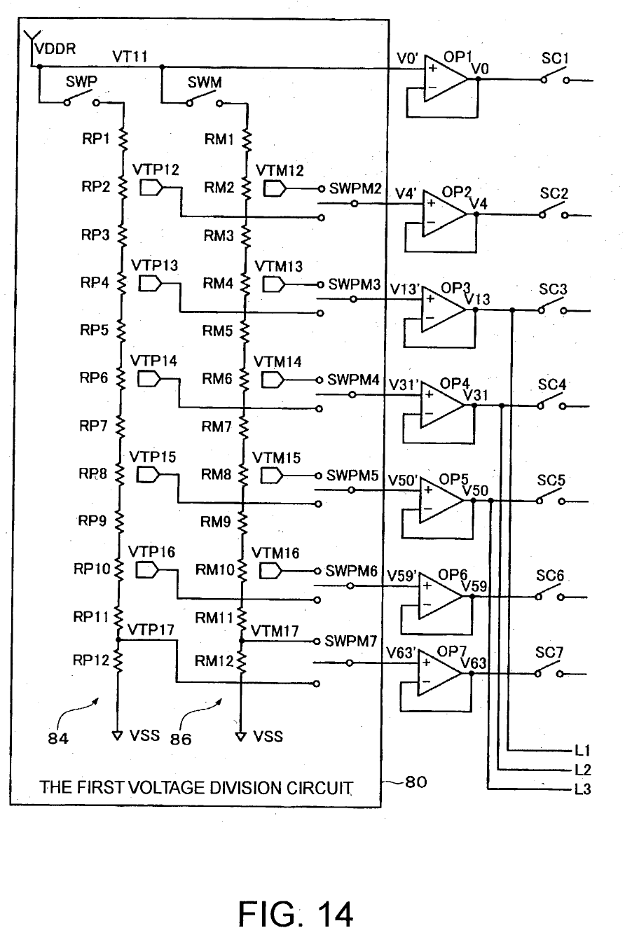

FIG. 14 shows another example of the first voltage division circuit 80.

The first voltage division circuit 80 in FIG. 14 includes a ladder resistor 84 for positive polarity, provided with resistance elements RP1 to RP12 connected in series, and a ladder resistor 86 for negative polarity, provided with resistance elements RM1 to RM12 connected in series.

The ladder resistor 84 for positive polarity is used during the period when the common voltage VCOM is the positive polarity (the period T1 in FIG. 2). On the other hand, the ladder resistor 86 for negative polarity is used during the period when the common voltage VCOM is the negative polarity (the period T2 in FIG. 2).

In detail, the switching element SWP is turned on and SWM is turned off during the positive polarity period of VCOM. In addition, a voltage of positive polarity is given to VDDR. Then, the switching elements SWPM2 to SWPM7 connect voltage division terminals VTP12 to VTP17 of the ladder resister 84 for positive polarity with input terminals of operational amplifiers OP1 to OP7.

On the other hand, during negative polarity period of VCOM, the switching element SWM is turned on, and SWP is turned off. In addition, voltage of negative polarity is given to VDDR. Then, the switching elements SWPM2 to SWPM7 connect voltage division terminals VTM 12 to VTM 17 of the ladder resistor 86 for negative polarity with input terminals of operational amplifiers OP1 to OP7.

In general, gamma correction characteristic (gray scale characteristic) becomes asymmetric between the period for positive polarity and the period for negative polarity of VCOM. Then, even if gamma correction characteristic becomes asymmetric, the ladder resistors 84 and 86 for positive polarity and negative polarity, are installed, shown in FIG. 14 and appropriate gamma correction, which is optimum for each of the periods for positive polarity and negative polarity, can be implemented thereby.

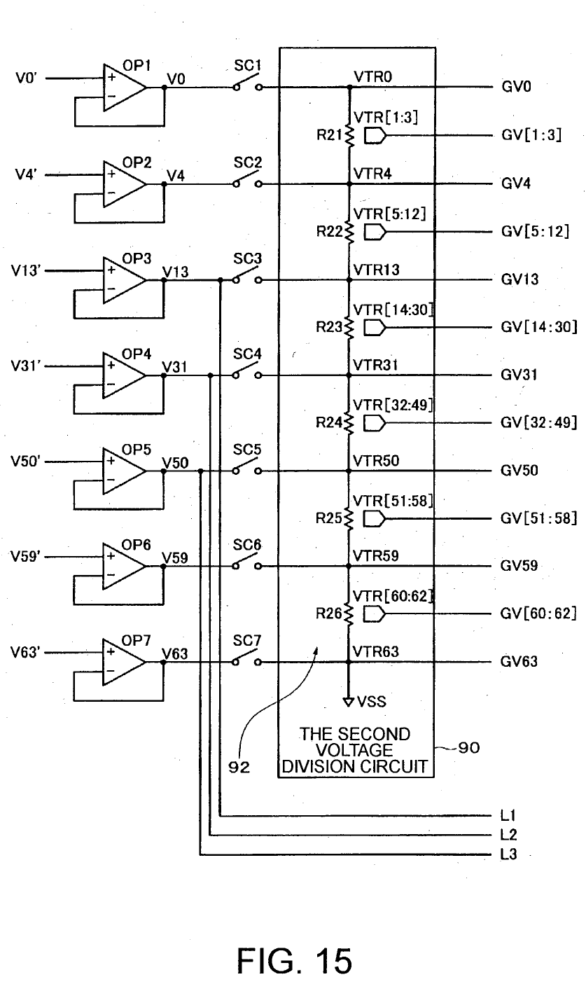

FIG. 15 shows an example of a second voltage division circuit 90.

This second voltage division circuit 90 includes a ladder resistor 92 with a plurality of resistor elements R21 to R26 connected in series. Voltage division terminals VTR0, VTR4, VTR13, VTR31, VTR50, VTR59, and VTR63 (M voltage division terminals) of the ladder resistor 92 are connected to the output terminals of the operational amplifiers OP1 to OP7. In addition, they output reference voltages GV0 to GV63 to voltage division terminals VTR0 to VTR63 of the ladder resistor 92 (N voltage division terminals).

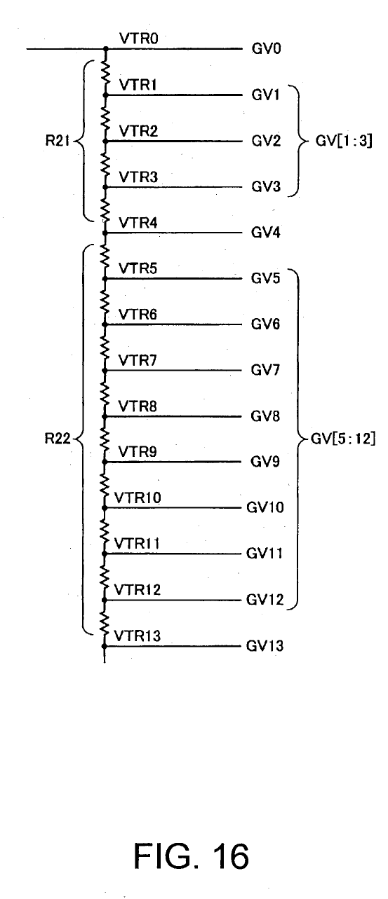

The voltage division terminals VTR [1:3], VTR [5:12] are obtained by dividing the resistance elements R21, R22 into further portions as shown in FIG. 16.

According to the second voltage division circuit 90 shown in FIG. 15, reference voltages GV0 to GV63 can be supplied by using operational amplifiers OP1 to OP7 having an impedance conversion function. Therefore, the output impedance of voltage division terminals VTR0 to VTR63 can be lowered. As a result, in case of removing operational amplifiers in the output circuit 40 shown in FIG. 9, it is easy to set data line voltage (pixel electrode voltage) for a desired gray scale voltage during a relatively short time.

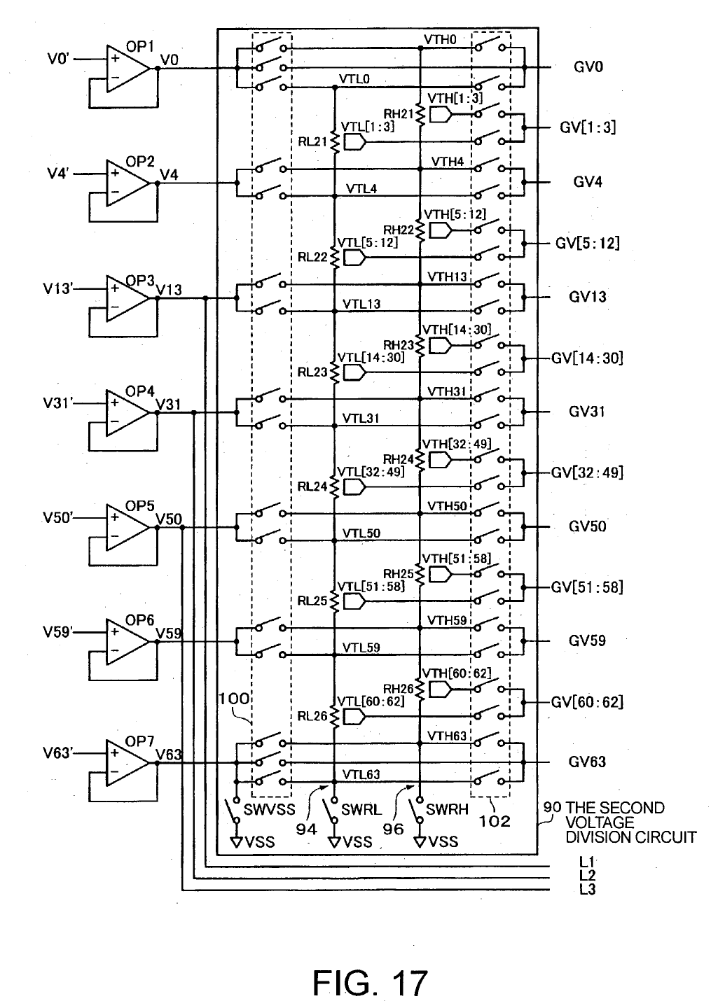

FIG. 17 shows another example of the second voltage division circuit 90.

The second voltage division circuit 90 includes a first ladder resistor 94 having relatively low resistivity (relative to the second ladder resistor, for example, 10 kΩ) with resistive elements RL21 to RL26 connected in series, and the second ladder resistor 96 having relatively high resistivity (relative to the first ladder resistor, for example, 20 kΩ) with resistive elements RH21 to RH26 connected in series.

In addition, the second voltage division circuit 90 includes the first switching portion 100 for switching resistors. This first switching portion 100 for switching resistors includes the switching element group, which connects either 7 (M) voltage division terminals VTL4, VTL13, VTL31, VTL50, VTL59, and VTL63 in the first ladder resistor 94, or 7 (M) voltage division terminals VTH0, VTH4, VTH13, VTH31, VTH50, VTH59, and VTH63 of the second ladder resistor 96 to output terminals of operational amplifiers OP1 to OP7 (impedance conversion circuits).

In FIG. 17, the first switching portion 100 for switching resistors implements the function of switching elements SC1 to SC7 in FIG. 11.

In addition, the second voltage division circuit 90 includes a second switching portion 102 for switching resistors. This second switching portion 102 for switching resistors includes the switching element group, which connects either 64 (N) voltage division terminals VTL0 to VTL63 in the first ladder resistor 94, or 64 pieces (N) voltage division terminals VTH0 to VTH63 in the second ladder resistor 96 to 64 (N) output terminals of reference voltages GV0 to GV63.

In addition, the first and second switching portions 100 and 102 for switching resistors include the switching elements that connect output terminals of operational amplifiers OP1 and OP7 directly to the output terminals of the reference voltages GV0 and GV63.

In addition, the switching element SWRL in FIG. 17 is turned on when the first ladder resistor 94 having relatively low resistivity is used and off when the second ladder resistor 96 having relatively high resistivity is used. On the other hand, the switching element SWRH is turned on when the second ladder resistor 96 having high resistivity is used and off when the first ladder resistor 94 having low resistivity is used. Installing these switching elements SWRL and SWRH can prevent the wasteful flow of current into the first and second ladder resistors 94 and 96 so as to attain low power consumption.

In addition, a switching element SWVSS of FIG. 17 is turned on when the voltage of a power source VSS is used as the reference voltage GV63 without using the output V63 of the operational amplifier OP7 as the reference voltage GV63.

The first ladder resistor 94 having low resistivity and the second ladder resistor 96 having high resistivity are included as shown in FIG. 17 so as to switch the first ladder resistor 94 with the second ladder resistor 96 depending on the situation. Hence, improvement of drive capability and low power consumption can be combined thereby.

Namely, if the first ladder resistor 94 having low resistivity is used, there is an advantage of lowering output impedance at the reference voltage terminals while there is a disadvantage of increasing current, which flows constantly in the ladder resistor. On the other hand, if the second ladder resistor 96 having high resistivity is used, there is an advantage of decreasing current, which flows constantly in the ladder resistor, while there is a disadvantage of increasing output impedance at the reference voltage terminals.

Therefore, if the first and second ladder resistors 94, 96 are switched, it is possible to restrict current flowing in the ladder resistor to a minimum while lowering the output impedance of the reference voltage output terminals as much as possible.

6. Output Circuit

Various kinds of structures can be adopted as the output circuit 40 included in the drive circuit of FIG. 9.

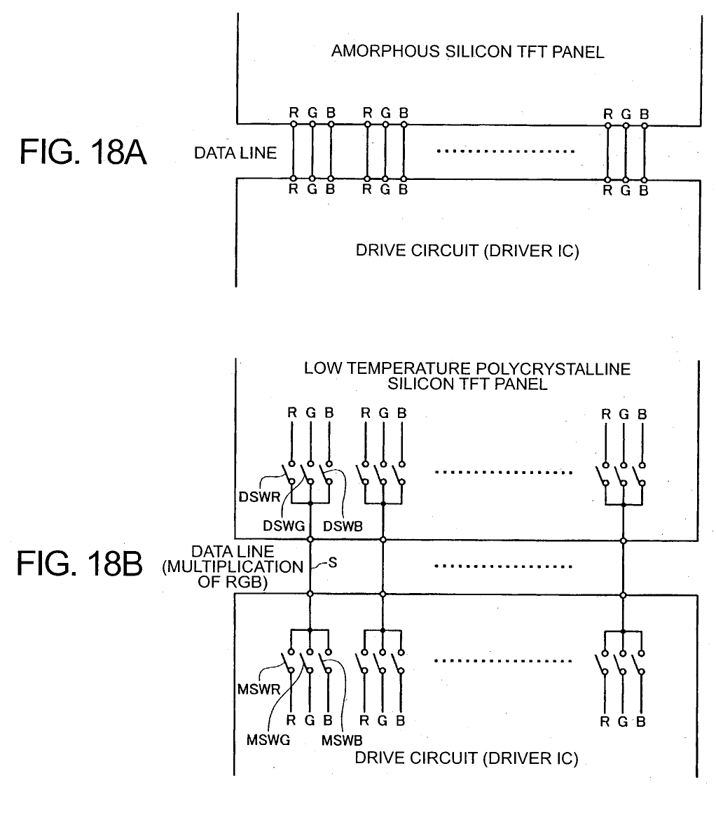

For example, in case of a display panel (generally, a first kind of display panel) where a TFT is formed by amorphous silicon, as shown in FIG. 18A, data line output terminals are installed in a driver IC (a drive circuit) corresponding to each of the data lines (source lines) for each color component R, G, and B (generally, the first, second, and third color components).

On the other hand, in case of a display (generally, a second kind of a display panel) where a TFT is formed by low temperature polysilicon (polycrystalline silicon), part of the circuitry can be formed on the panel. Hence, in order to reduce the number of wires between the display panel and the drive circuit, the display panel can be connected with the driver IC by data lines that multiplex and transmit data signals for R, G and B, as shown in FIG. 18B.

Namely, in this circuit of FIG. 18B, switching elements MSWR, MSWG, and MSWB for multiplexing are installed in the driver IC side. Hence, data signals for R, G, and B are multiplexed by using these switching elements MSWR, MSWG, and MSWB, and transmitted to the display side via one data line S.

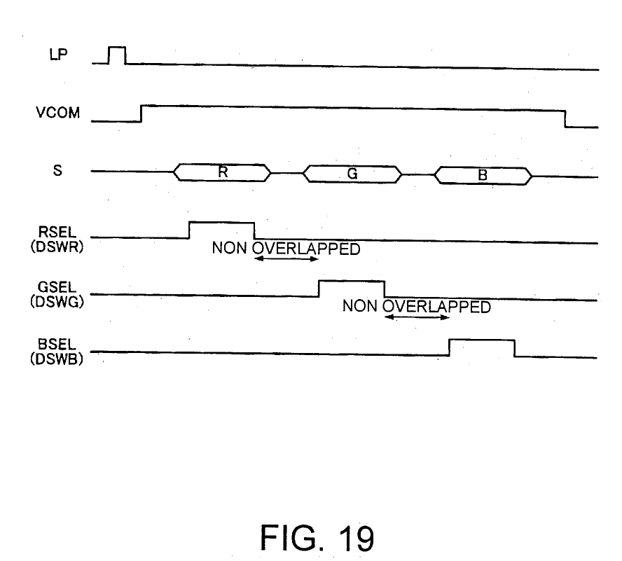

Switching elements DSWR, DSWG, and DSWB are installed for demultiplexing on the display panel side. Data signals for R, G, and B, multiplexed and transmitted by one data line S are separated from each other by switching elements DSWR, DSWG, and DSWB for demultiplexing and supplied to each of pixels for R, G and B. In detail, these switching elements DSWR, DSWG, and DSWB are controlled to turn on or off by using switching signals RSEL, GSEL, BSEL as shown in FIG. 19, so as to separate data signals for R, G, and B. In addition, in FIG. 19, LP stands for a horizontal synchronization signal (latch pulse).

According to this circuit and method shown in FIG. 18B, there is an advantage in that the number of wires between a display panel and a driver IC can be reduced such that the area of mounting wires can be small and a compact device can be achieved.

The output circuit 40 in the present embodiment may include switching elements for multiplexing MSWR, MSWG and MSWB as shown in FIG. 18B. Even in this output circuit 40, the voltage VS of the data line S can be set to a desired gray scale voltage within a short time by changing VS to the VDDR side or VSS during the period after the timing of polarity change of VCOM.

In addition, the present invention is not limited to the present embodiment and various modifications can be made within the sprit of the invention.

For example, in the present embodiment, applying the drive circuit of the present invention to an active matrix liquid crystal device using TFT was described, but the present invention is not so limited. For example, the drive circuit of the present invention can be applied to a liquid crystal device other than an active matrix liquid crystal device, and an electro-optical device such as an electro luminescence (EL) device, an organic EL device and a plasma display may be used.

In addition, the structures of the drive circuit are not limited to the structures explained in FIG. 5 to FIG. 19 and various kinds of equivalent structures can be adopted.

In addition, the present invention is not limited to a drive method that changes polarity every scanning line, but can be applied to other drive methods for changing polarity.

In addition, in the some parts of description in the specification, the nomenclatures (operational amplifier, impedance conversion circuit, TFT, liquid crystal element, display panel, liquid crystal device, VDDR, VSS and others) were cited as the nomenclatures, which are defined in a general sense as voltage setting circuit, operational amplifier, switching element for pixel, electro-optical material, electro-optical panel, the first and second power sources, and others. Such nomenclatures can also be replaced with the nomenclatures in the general sense even in other parts of description in the specification.

What is claimed is:

1. A drive circuit for driving a display panel including a plurality of pixels, a plurality of scanning lines and a plurality of data lines, the data lines being divided into a plurality of data line groups, comprising:
a plurality of voltage-setting circuits each corresponding to a respective one of the plurality of data lines groups;
each of the voltage-setting circuits changing a voltage source for a respective data line group to a first voltage source or a second voltage source, when the voltage of the respective data line group varies toward the other of the first voltage source or the second voltage source due to a polarity change of a voltage applied to a pixel electrode provided with each pixel in the display panel and an opposite electrode that sandwiches electro-optical material therebetween.

2. A drive circuit as in claim 1, wherein;
each of the voltage-setting circuits changes the voltage source of the respective data line group to a first voltage source or a second voltage source during a predetermined period after the time of polarity change of the voltage applied to the opposite electrode.

3. A drive circuit as in claim 1, further comprising;
a reference voltage production circuit that produces a plurality of reference voltages;
a digital to analog conversion circuit that converts digital gray scale data to analog gray scale voltage using the plurality of reference voltages; and
an output circuit that outputs analog gray scale voltage from the digital to analog conversion circuit to each data line; and wherein
the plurality of the voltage-setting circuits comprise a plurality of impedance conversion circuits included in the reference voltage production circuit.

4. The drive circuit as in claim 3, wherein
the reference voltage circuit comprises:
a first voltage division circuit that includes a ladder resistor with a plurality of resistive elements connected in series, and outputs M (M≧4) voltages to M voltage division terminals of the ladder resistor, and
M impedance conversion circuits that input M voltages from the first voltage division circuit to each of a plurality of input terminals and output voltages for producing reference voltages to each of a plurality of output terminals; and
the plurality of the voltage-setting circuits comprise k (2≦k≦M−2) impedance conversion circuits excluding at least the impedance conversion circuits located on the first and second power source sides among the M impedance conversion circuits.

5. The drive circuit as in claim 4, wherein
the reference voltage production circuit includes a second voltage division circuit including a ladder resistor with a plurality of resistive elements connected in series, connecting M voltage division terminals of the second ladder resistor to the output terminals of M impedance conversion circuits, and outputting reference voltages to reference voltage output terminals that are N (N≧2×M) output voltage terminals of the second ladder resistor.

6. The drive circuit as in claim 5, further comprising
a first switching element group connected between the output terminal of the digital to analog conversion circuit and the data lines, and
a second switching element group connected between the output terminal of a plurality of impedance conversion circuits and the data lines, wherein;
the first switching element group is turned off and the second switching element group is turned on during the period of polarity change of the opposite electrode.

7. An electro-optical device including the drive circuit as in claim 1 and a display panel driven by the drive circuit.

8. A drive circuit for driving a display panel including a plurality of pixels, a plurality of scanning lines and a plurality of data lines, comprising:
a reference voltage production circuit that produces a plurality of reference voltages;
a digital to analog conversion circuit that converts digital gray scale data to analog gray scale voltages using the plurality of reference voltages; and
an output circuit that outputs analog gray scale voltages from the digital to analog conversion circuit to the data lines;
the reference voltage production circuit comprising one or a plurality of impedance conversion circuits that changes a voltage source for the data lines to a first voltage source or a second voltage source, when the voltage of the data line voltage varies toward the other of the first voltage source or the second voltage source due to a polarity change of a voltage applied to a pixel electrode provided with the pixel in the display panel and a opposite electrode that sandwiches electro-optical material therebetween.

9. The drive circuit as in claim 8, wherein
the data line is set in a high impedance state during a predetermined period including the time when the polarity of the opposite electrode voltage is changed.

10. An electro-optical device including the drive circuit as in any of claim 8 and a display panel driven by the drive circuit.

11. A method for driving a display panel including a plurality of pixels, a plurality of scanning lines and a plurality of data lines, the data lines being divided into a plurality of data line groups, and a plurality of voltage-setting circuits each corresponding to a respective one of the plurality of data lines groups, comprising:
changing a voltage source for a respective data line group to a first voltage source or a second voltage source, when the voltage of the respective data line group varies toward the other of the first voltage source or the second voltage source due to a polarity change of a voltage applied to a pixel electrode provided with each pixel in the display panel and an opposite electrode that sandwiches electro-optical material therebetween.

12. A method for driving a display panel including a plurality of pixels, a plurality of scanning lines and a plurality of data lines, comprising:
producing a plurality of reference voltages;
converting digital gray scale data to analog gray scale voltages using the plurality of reference voltages;
outputting the analog gray scale voltages to the data lines; and
changing a voltage source for the data lines to a first voltage source or a second voltage source, when the voltage of the data line voltage varies toward the other of the first voltage source or the second voltage source due to a polarity change of a voltage applied to a pixel electrode provided with the pixel in the display panel and a opposite electrode that sandwiches electro-optical material therebetween.
